(19) United States
(12) Patent Application Publication
(10) Pub. No.: US 2013/0140966 A1
(43) Pub. Date: Jun. 6, 2013

(54) MOBILE DEVICES WITH MECHANICALLY BONDED CONNECTOR ASSEMBLIES AND METHODS FOR FORMING SUCH MOBILE DEVICES

(71) Applicant: Bart Peter Reier, Cary, NC (US)

(72) Inventor: Bart Peter Reier, Cary, NC (US)

(73) Assignee: HTC CORPORATION, Taoyuan City (TW)

(21) Appl. No.: 13/311,843

(22) Filed: Dec. 6, 2011

(51) Int. Cl. H05K 5/02; B23P 11/00

(52) U.S. Cl. 312/223.1; 29/428

(57) ABSTRACT

Mobile devices with mechanically bonded connector assemblies and methods for forming such mobile devices are provided. A representative mobile device includes: a housing comprising a metal chassis; and a plastic connector assembly mechanically bonded to the metal of the chassis. A representative method includes: providing a metal chassis, the chassis defining an interior; and mechanically bonding a plastic connector assembly to the chassis, the connector being located within the interior.

### TECHNICAL FIELD

The present disclosure generally relates to mobile devices.

### BACKGROUND

Various devices such as mobile devices (e.g., smartphones, handheld GPS devices, etc.) trend toward the characteristics of small size and light weight. This is particularly the case with housings of such devices. However, it is difficult to reduce the weight of such devices without reducing desirable mechanical properties, such as resistance to torsional loads.

### SUMMARY

Briefly described, one example embodiment, among others, is a mobile device that incorporates a housing, wherein the housing comprises a metal chassis; and a plastic connector assembly mechanically bonded to the metal of the chassis.

Another example embodiment is a method for forming a mobile device comprising: providing a metal chassis, the chassis defining an interior; and mechanically bonding a plastic connector assembly to the chassis, the connector being located within the interior.

Another example embodiment comprises a mobile device formed by a disclosed method.

Other systems, methods, features and/or advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a partially-exploded, schematic view of an example embodiment of a mobile device.

FIG. 2 is a partially cut-away, cross-sectional view of the embodiment of FIG. 1 showing detail of a flow portion of the plastic part and a corresponding recess.

FIG. 3 is a flowchart depicting an example embodiment of a method for forming a mobile device.

FIG. 4 is a flowchart depicting another example embodiment of a method for forming a mobile device.

FIGS. 5-7 are schematic views showing detail of two connector assemblies.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiments disclosed herein. Rather, the intent is to cover all alternatives, modifications and equivalents included within the spirit and scope of the disclosure as defined by the appended claims.

Mobile devices with mechanically bonded connector assemblies and methods for forming such mobile devices are provided. In some embodiments, recesses are formed in a metal chassis and then the chassis is placed in a mold. Plastic is flowed into the mold to form at least a portion of a connector assembly and portions of the plastic enter the recesses prior to solidifying. The flow portions of the plastic positioned within the recesses create unexpectedly firm mechanical bonds. In some embodiments, the plastic is used to create guide ribs that define a cavity into which a connector is placed. By way of further example, the plastic may be used to form the connector itself.

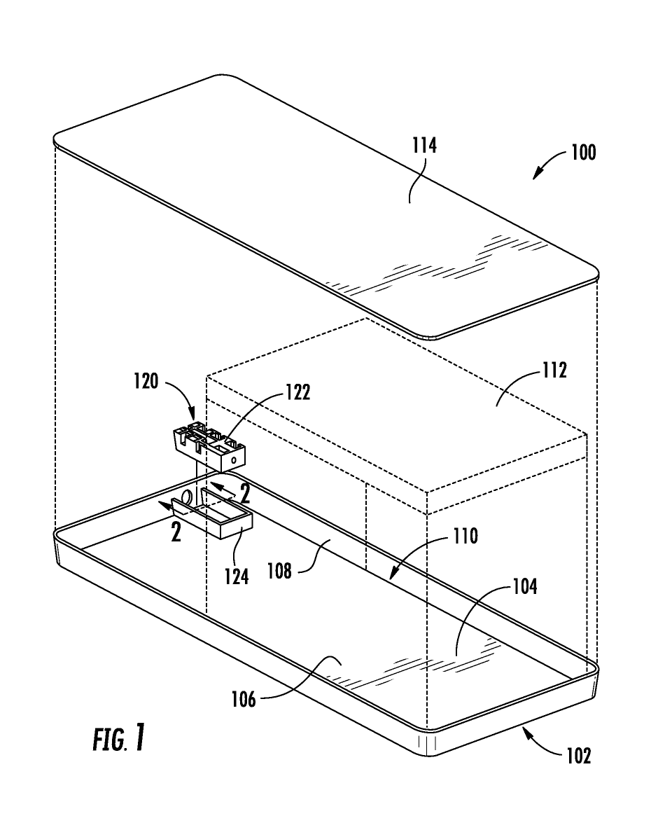

As shown in FIG. 1, an embodiment of a mobile device 100 includes a housing 102 that incorporates a metal chassis 104. The chassis incorporates a base 106 and a sidewall 108, with the sidewall extending outwardly from the base and being positioned about the periphery of the base. The housing defines an interior 110 in which internal components 112 (the details of which are not described herein) are mounted. A transparent cover 114 engages the housing to encase the internal components.

Also mounted within the interior is a connector assembly 120 that includes a connector body 122 and guide ribs 124. The guide ribs are directly molded to the metal chassis by flowing plastic into recesses that are formed in the surface of the chassis. As such, the recesses form bonding locations for the plastic ribs.

In this embodiment, the recesses are formed by chemically etching the recesses into the surface of the chassis using a process known as Nano Molding Technology (NMT). In other embodiments, various other forms of direct metal-to-plastic bonding techniques may be used. For instance, in other embodiments, other methods for forming recesses may be used. Additionally, or alternatively, various adhesion methods, such as selective surface application of adhesive primer on a chassis may be performed prior to introducing plastic into the mold, among others.

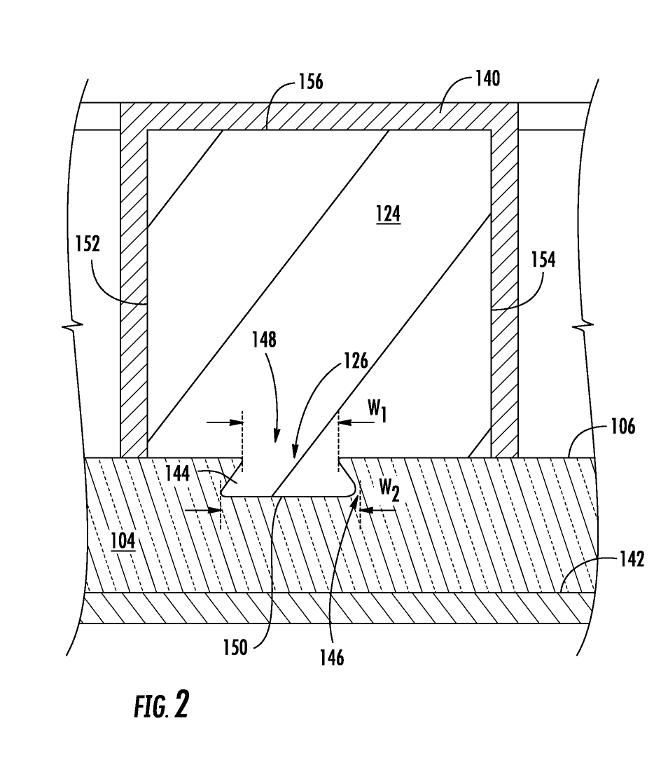

In the embodiment of FIGS. 1 and 2, the recesses are arranged to form the bonding locations at which the guide ribs are to mechanically bond to the metal of the chassis. Specifically, the recesses are positioned at locations where the ribs contact the chassis.

As shown in more detail in FIG. 2, after forming the recesses, the housing is positioned within a mold that includes mold surfaces 140, 142. Plastic is flowed into the mold and a flow portion 144 of the plastic enters the recess where it is permitted to harden. Preferably, a viscosity of the plastic is selected to enable the plastic to completely fill the recess although some voids (e.g., void 146) may be present.

In this embodiment, the recesses exhibit necked regions that essentially form interference fits with respective flow portions of the plastic part. For instance, recess 126 exhibits a width that varies with respect to its depth to form a necked region 148 with a width (w₁) that is narrower than the width (w₂) of base 150. Various other dimensions of a recess that may or may not include a necked region may be used in other embodiments.

In the embodiment of FIG. 2, guide rib 124 includes opposing surfaces 152, 154 and an upper surface 156 such that the cross-section of the guide rib is substantially rectangular.

FIG. 3 is a flowchart depicting an exemplary embodiment of a method for forming a mobile device. As shown in FIG. 3, the method includes: providing a metal chassis, with the chassis defining an interior (block 160); and mechanically bonding a plastic connector assembly to the chassis via flow portions of the plastic, with the connector being located within the interior (block 162). In some embodiments, a connector body of the connector assembly is mechanically bonded to the chassis. However, there are other manners of providing a connector assembly.

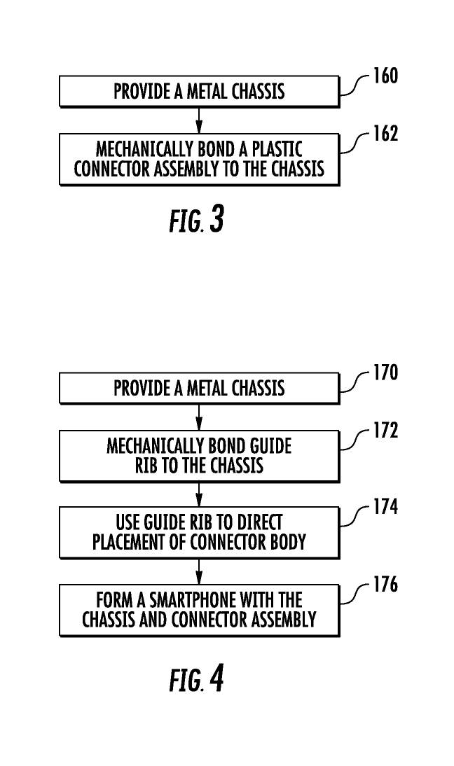

In this regard, FIG. 4 is a flowchart depicting another exemplary embodiment of a method. As shown in FIG. 4, the method includes: providing a metal chassis, with the chassis defining an interior (block 170). In block 172, a guide rib of a plastic connector assembly is mechanically bonded to the chassis via flow portions of the plastic, with the connector being located within the interior. As depicted in block 174, the guide rib is used to direct placement of the connector body during mounting of the connector body to the chassis. In block 176, the chassis and connector assembly are used to form a smartphone.

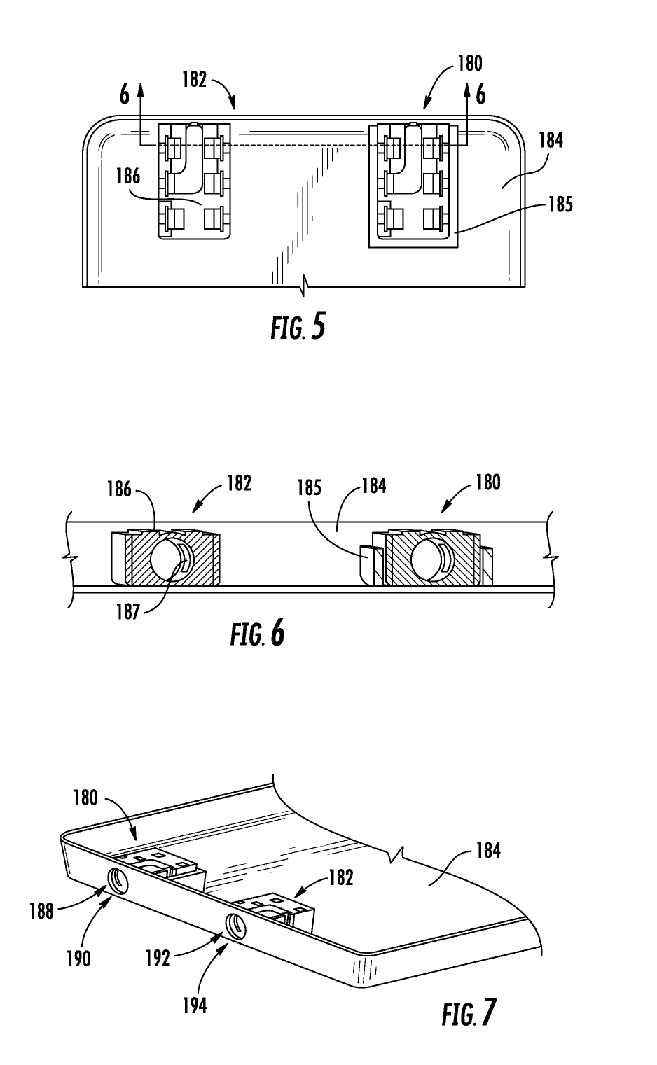

FIGS. 5-7 are schematic views showing detail of two connector assemblies for ease of comparison. Specifically, connector assembly 180, which is similar to that described before with respect to connector assembly 120 of FIG. 1, and connector assembly 182 are shown mounted to a chassis 184.

In contrast to forming guide ribs (e.g., guide ribs 185), connector assembly 182 lacks such ribs. Notably, connector body 186 is formed directly onto the chassis during the molding process in the manner described before for forming the guide ribs. As such, connector assembly 184 uses less space than connector assembly 180 even though the dimensions of the connector bodies are identical. After forming of connector body 186, electrical contacts (e.g., contact 187) are loaded into the connector body to complete the installation.

Note in FIG. 7 that receptacles of the connector assemblies are aligned with corresponding through-holes positioned along the sidewall of the chassis. Specifically, receptacle 188 is aligned with through-hole 190, and receptacle 192 is aligned with through-hole 194.

By providing connector assemblies such as the example embodiments described above, there is no need to provide non-cosmetically acceptable mechanical interlocks, which are currently needed for traditional insert molding techniques. Additionally, high precision of connector body placement may be achieved either directly in the mold process or indirectly by using guide ribs. Further, mechanically bonding the connector assembly to the chassis provides for a cleaner interface and allows the through-hole of the chassis to be smaller since cumulative assembly tolerances are reduced.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A mobile device comprising:
a housing comprising a metal chassis; and
a plastic connector assembly mechanically bonded to the metal of the chassis.

2. The mobile device of claim 1, wherein:
the metal chassis has first recesses formed therein; and
the plastic connector assembly is mechanically bonded to the metal of the chassis via first flow portions of the plastic of the connector assembly being positioned within the first recesses.

3. The mobile device of claim 1, wherein:
the connector assembly comprises a guide rib and a connector body; and
the guide rib is mechanically bonded to the metal of the chassis and sized and shaped to facilitate placement of the connector body.

4. The mobile device of claim 3, wherein the guide rib defines a cavity sized to receive the connector body and shaped to orient the connector body relative to the chassis.

5. The mobile device of claim 3, wherein:
the chassis has a base and a sidewall, the sidewall extending upwardly from the base at a perimeter thereof; and
the guide rib extends upwardly from the base and inwardly from the sidewall.

6. The mobile device of claim 3, wherein:
the chassis has a base and a sidewall, the sidewall extending upwardly from the base at a perimeter thereof; and
the guide rib is a U-shaped member having distal ends, the distal ends being mechanically bonded to the sidewall of the chassis.

7. The mobile device of claim 2, wherein the connector assembly comprises a connector body mechanically bonded to the metal of the chassis.

8. The mobile device of claim 1, wherein the mobile device is a smartphone.

9. A method for forming a mobile device comprising:
providing a metal chassis, the chassis defining an interior; and
mechanically bonding a plastic connector assembly to the chassis, the connector being located within the interior.

10. The method of claim 9, wherein, in mechanically bonding the plastic connector assembly to the chassis, flow portions of the plastic of the connector are used to engage within recesses formed in the chassis.

11. The method of claim 9, wherein:
the connector assembly has a connector body and a guide rib; and
mechanically bonding the plastic connector assembly to the chassis comprises mechanically bonding the guide rib to the chassis.

12. The method of claim 11, wherein mechanically bonding the guide rib to the chassis comprises mechanically bonding distal ends of the guide rib to a sidewall of the chassis.

13. The method of claim 11, further comprising using the guide rib to direct placement of the connector body during mounting of the connector body to the chassis.

14. The method of claim 10, wherein:
the connector assembly has a connector body; and
mechanically bonding the plastic connector assembly to the chassis comprises mechanically bonding the connector body to the chassis.

15. The method of claim 14, further comprising loading electrical contacts into the connector body.

16. The method of claim 14, wherein mechanically bonding the connector body to the chassis comprises forming the connector body within the interior of the chassis.

17. The method of claim 10, further comprising using the chassis and connector assembly to form a smartphone.

18. A mobile device formed by the method of claim 10.
